(19) United States
(12) Patent Application Publication
(10) Pub. No.: US 2004/0121059 A1
(43) Pub. Date: Jun. 24, 2004

(54) Soy isoflavone concentrate process and product

(76) Inventor: Navpreet Singh, Fort Wayne, IN (US)

Correspondence Address: Mr. Richard B. Taylor, Solae, LLC, P.O. Box 88940, St. Louis, MO, 63188, US

(21) Appl. No.: 10/693,401

(22) Filed: Oct. 24, 2003

Related U.S. Application Data
(60) Provisional application No. 60/420,916, filed on Oct. 24, 2002.

(51) Int. Cl. A23L 1/00

(52) U.S. Cl. 426/507

(57) ABSTRACT

A soy isoflavone concentrate that has an isoflavone content of 50 wt. % moisture free basis (“mfb”) or greater. The process for producing the soy isoflavone concentrate uses a combination of an ultrafiltration process and a liquid-liquid extraction to obtain a high soy isoflavones concentration without the need for additional extraction or purification steps. A soy isoflavone concentrate is provided having at least 50 wt. % isoflavones (mfb), inclusive of at least 15 wt. % daidzin (mfb), at least 20 wt. % genistin (mfb), and at least 4 wt. % glycitin (mfb). A process for producing the soy isoflavone concentrate includes the steps of providing soy molasses or soy solubles, diluting the soy molasses with water, ultrafiltering the solubles from the water-diluted soy molasses to obtain a permeate, and extracting the permeate with ethyl acetate to obtain an extract that has at least 50 wt. % isoflavones (mfb).

### CROSS REFERENCE TO RELATED APPLICATIONS

This application claims the benefit under Title 35, U.S.C. § 119(e) of U.S. Provisional Patent Application Serial No. 60/420,916, entitled SOY ISOFLAVONE CONCENTRATE PROCESS AND PRODUCT, filed on Oct. 24, 2002.

### BACKGROUND OF THE INVENTION

1. Field of the Invention.

This invention relates to isoflavones, and more particularly relates to methods for recovering isoflavones from soy molasses or soy solubles and a composition that has a high soy isoflavone concentration.

2. Description of the Related Art.

This invention relates to a process for making an isoflavone concentrate product from soybeans. Isoflavones are a unique class of phytoestrogens, plant hormones that naturally occur in soybeans.

It is anticipated that consumer demand for soy isoflavones will continue to grow. Scientists have demonstrated that isoflavones may have the ability to inhibit cancer cell growth, and some researchers believe that isoflavones may contribute to the ability of soybean consumption to lower blood cholesterol levels.

Research shows that soy isoflavones have a wide range of health benefits that include moderating normal symptoms associated with menopause and promoting bone and heart health. It has been asserted that about 100 milligrams of isoflavones (expressed in the glucoside form) are necessary to deliver most of these health benefits. This is about the average amount consumed daily by many Asian men and women who have a much lower incidence of heart disease, osteoporosis and uncomfortable menopausal symptoms as compared to men and women of Western societies.

Some women's health problems during and after middle age are related to a changing hormonal state. Consuming soy isoflavones can help moderate the natural hormonal changes associated with several menopausal and postmenopausal symptoms.

Soy isoflavones are potent antioxidants capable of reducing the amount of LDL-cholesterol (i.e., “bad” cholesterol) that undergoes modification in the body. Entry of the modified LDL-cholesterol into the walls of blood vessels contributes to the formation of plaques. These plaques cause the blood vessels to lose their ability to function normally. Research in both animals and humans shows that ingesting soy isoflavones can help maintain normal blood vessel function.

Soy isoflavones are currently being actively studied for their effects on maintaining and improving bone health. Some studies have shown that women can lose up to 15% of their total bone mass in the early years following the onset of menopause. This loss can be quite detrimental, particularly to women who enter menopause with weaker bones. Emerging research shows that isoflavones appear to play a role in both preventing bone loss and increasing bone density.

It has recently been recognized that the isoflavones contained in vegetable proteins such as soybeans may inhibit the growth of human cancer cells, such as breast cancer cells, prostate cancer cells and colon cancer cells. In addition, isoflavones also have been found to reduce cardiovascular risk factors, for example by reducing the levels of atherosclerosis inducing lipoproteins and low density cholesterol and by increasing endothelial dependent vasodilation response. Isoflavones are also showing great promise in preventing osteoporosis and treating menopausal symptoms.

Isoflavones occur in a variety of leguminous plants and oilseeds, including vegetable protein materials such as soybeans. These compounds generally include daidzin, 6″-O-acetyldaidzin, 6″-O-malonyldaidzin, daidzein, genistin, 6″-O-acetylgenistin, 6″-O-malonylgenistin, genistein, glycitin, 6″-O-malonylglycitin, glycitein, biochanin A, and formononetin. The principal types of isoflavones found in soybeans are glucones (with sugars) and aglucones (without sugars). Glucones have the glucose molecule attached, and include genistin, daidzin and glycitin. Aglucones are isoflavones without the glucose molecule, and they include genistein, daidzein and glycitein.

U.S. Pat. No. 6,146,668 to Kelly et al. describes liquid-liquid extraction of isoflavones from soy flour by forming slurry of defatted soy material, cleaving glycoside in the slurry to form aglucone using an enzyme, and simultaneously extracting the slurry with ethyl acetate. Next, the extract is purified by another liquid-liquid extraction step that uses hexane as the solvent. The resulting product has an isoflavone concentration of greater than 40 wt. %. However, the isoflavones are in aglucone form.

U.S. Pat. No. 6,517,840 to Kozak et al. describes liquid-liquid extraction of isoflavones from soy molasses diluted with water using one solvent, followed by another liquid-liquid extraction of the extract of the first extraction with a non-polar solvent.

U.S. Pat. Nos. 5,702,752 and 5,792,503, both to Gugger et al., describe the production of isoflavone enriched fractions from soy protein extracts that involves subjecting soy molasses to ultrafiltration to obtain a permeate that includes isoflavones that can be recovered either by crystallization or by an adsorption process.

It is an objective of this invention to develop a process that, starting with soy molasses, uses only one liquid-liquid extraction and hence the process will use only one solvent, thus simplifying the process significantly.

### SUMMARY OF THE INVENTION

The present invention provides a soy isoflavone concentrate that has an isoflavone content of 50 wt. % moisture free basis (“mfb”) or greater. The process for producing the soy isoflavone concentrate uses a combination of an ultrafiltration process and a liquid-liquid extraction to obtain a high soy isoflavones concentration without the need for additional extraction or purification steps. A soy isoflavone concentrate is provided having at least 50 wt. % isoflavones (mfb), inclusive of at least 15 wt. % daidzin (mfb), at least 20 wt. % genistin (mfb), and at least 4 wt. % glycitin (mfb). A process for producing the soy isoflavone concentrate includes the steps of providing soy molasses or soy solubles, diluting the soy molasses with water, ultrafiltering the solubles from the water-diluted soy molasses to obtain a permeate, and extracting the permeate with ethyl acetate to obtain an extract having at least 50 wt. % isoflavones (mfb).

The process for obtaining the present soy isoflavone concentrate involves ultrafiltering water-diluted soy molasses and subsequent ethyl acetate extraction of the resulting permeate, eliminating the need of any further extraction or purification steps of the isoflavone concentrate.

In one form thereof, the present invention provides a process for producing a soy isoflavone concentrate, including the steps of: (a) providing soy molasses; (b) diluting the soy molasses with water to obtain water-diluted soy molasses; (c) subjecting the water-diluted soy molasses to ultrafiltration to obtain a permeate; (d) extracting the permeate with ethyl acetate to obtain an extract; and (e) removing ethyl acetate from the extract to obtain a soy isoflavone concentrate.

In another form thereof, the present invention provides a soy isoflavone concentrate, including: at least 50 wt. % isoflavones on a moisture-free basis, inclusive of: at least 15 wt. % daidzin; at least 20 wt. % genistin; and at least 4 wt. % glycitin.

### DETAILED DESCRIPTION

A soy isoflavone concentrate is provided having at least 50 wt. % isoflavones (mfb), inclusive of at least 15 wt. % daidzin (mfb), at least 20 wt. % genistin (mfb), and at least 4 wt. % glycitin. In a preferred form, the G:D (genistin:daidzin) ratio of the present soy isoflavone concentrate is from about 1.0 to about 1.6 and the G:G (genistin:glycitin) ratio is from 3.0 to 5.0.

A method for producing a soy isoflavone concentrate is provided, including the steps of providing soy molasses, diluting the soy molasses with water, ultrafiltering the soy solubles from the water-diluted soy molasses to obtain a permeate, and extracting the permeate with ethyl acetate to obtain an extract having more that 50 wt. % isoflavones (mfb).

Soy molasses, which is also sometimes referred to in the art as “soy solubles”, is a product derived from the aqueous ethanol extraction of hexane-defatted soybean flakes. Typically, the defatted soybean flakes are extracted with aqueous ethanol (usually between 60 and 80 % ethanol by volume) at temperatures in the range of between 44 and 63° C. (120 -150° F.). The aqueous ethanol extract is then subjected to vacuum distillation or other suitable process to remove the ethanol. This alcohol-stripped extract is known as “soy molasses” or “soy solubles.” Soy molasses is commercially available from many sources, typically in the form of a slurry having a solids content of between 55 wt. % and 65 wt. %.

While the soy molasses which is used as the starting material in the present process can be prepared from defatted soybean material or harvested soybeans according to known processes, for purposes of simplicity, the present invention will be described using soy molasses as a starting material. It is to be understood that soy molasses can either be obtained from one or more commercial suppliers, or otherwise prepared by one of many known methods.

The isoflavone content of soy molasses varies widely. Soy molasses which may be used as a starting material for the present process may include between 0.5 wt. % and 1.5 wt. % isoflavones, preferably greater than 1 wt. % isoflavones. Soy molasses typically has a crude fat content of between 4 wt. % and 12 wt. %, a crude fiber content of between 0.3 wt. % and 2 wt. %, a protein content of between 13 wt. % and 17 wt. %, and a sugars content of at least 35 wt. %. However, the foregoing may vary substantially in soy molasses.

Generally, the present method encompasses the steps of diluting soy molasses with water; ultrafiltering the solubles from the water-diluted soy molasses to obtain a permeate; and extracting the permeate with ethyl acetate to obtain an extract that has more that 50 wt. % isoflavones.

The first step of diluting the soy molasses with water involves substantially homogeneously mixing soy molasses and water together. This mixing can be conducted using any suitable apparatus, such as a stirred tank which is optionally provided with an apparatus for heating the contents of the tank. The ratio at which the soy molasses may be diluted with water typically effects the concentration of isoflavones in the final soy isoflavone concentrate, and may vary. Dilution ratios of between 1:1 and 4:1 (water:solubles) have been found to be acceptable, while dilution ratios of between 1:1 and 3:1 are preferred, and dilution ratios of between 2:1 and 3:1 are particularly preferred.

After dilution, the substantially homogeneous mixture of soy molasses and water can be subjected to an optional pre-filtering step to remove large particle components. For example, the mixture may be filtered through a sieve, such as a US Standard No. 25 sieve (0.707 mm sieve opening) before proceeding to the subsequent ultrafiltration step. Alternatively, the mixture may be filtered using a 100-mesh (149 μm) strainer, for example.

In the next step, the diluted soy molasses mixture is ultrafiltered using a 1,000 to 300,000 molecular weight cut-off (“MWCO”) membrane, preferably a 5000 to 100,000 MWCO membrane, to obtain a permeate. Suitable spiral-wound membranes of different MWCO are readily and commercially available from several vendors, such as Koch Membrane Systems of Wilmington, Mass.; Osmonics of Minnetonka, Minn.; PTI Advanced Filtration of Oxnard, Calif.; and Synder Filtration of Vacaville, Calif. Suitable ceramic membranes of different MWCO are readily and commercially available from several vendors, such as Atech Innovations of Gladbeck, Germany, Tami Industries of Nyons, France, Pall Exekia of Bazet, France and Orelis of Miribel Cedex, France.

In order to enhance the solubility of the isoflavones during the ultrafiltration step, the temperature of the substantially homogeneous mixture of soy molasses and water can be kept between 50 and 85° C. (122 -185° F.) and more preferably between 60 and 82° C. (140 -180° F.) during the ultrafiltration process. It was determined that the use of a ceramic membrane was particularly suitable for operation over this temperature range. A preferred membrane is a ceramic membrane having a MWCO of 15,000. This membrane is freely available from a number of commercial suppliers such as those set forth above.

In the next step, isoflavones are extracted from the permeate using ethyl acetate. The extraction step can be carried out at a temperature of between 20 and 25° C. (68 -77° F.) by mixing the ethyl acetate together with the permeate at a ratio of between 1:1 and 20:1, and more preferably 5:1 (Ethyl acetate:permeate). After mixing, the extract (top layer) is separated from the remainder of the permeate by a suitable process such as decanting. Thereafter, the ethyl acetate is removed from the separated extract by evaporation or by another suitable process, and may be dried to yield a soy isoflavone concentrate in powdered form. An evaporator, such as a rising film evaporator or a falling film evaporator, may be used. Suitable dryers include tray dryers and drum dryers.

Optionally, the permeate may be again extracted one or more additional times with ethyl acetate, followed by separation of the extract from the remainder of the permeate. Multiple extractions reduces the isoflavones remaining in the permeate.

It has been found that treating diluted soy molasses or soy solubles by ultrafiltration, and subsequently extracting isoflavones with ethyl acetate, eliminates the need for further purification of the soy isoflavone concentrate using hexane extraction. Moreover, the resulting soy isoflavone concentrate has appreciably higher isoflavone content than in known methods. The ultrafiltration membrane used according to the present invention retains the protein, insoluble matter and parts of fat components, while allowing isoflavones, saponins, and sugars to permeate through the membrane when the membrane filtration process is operated at the above temperatures in which isoflavones are soluble.

The isoflavones composition was analyzed by the procedure described in Thiagarajan, D. G., Bennink, M. R., Bourquin, L. D., and Kavas, F. A., Prevention of Precancerous Colonic Lesions in Rats by Soy Flakes, Soy Flour, Genistein, and Calcium, Am. J. Clin. Nutr. 1998; 68(suppl); 1394S-9S.

These and other aspects of the present invention may be more readily understood by reference to one or more of the following non-limiting examples. In the examples and throughout, percentages are by weight unless otherwise indicated.

### EXAMPLE 1

2.0 kg of soy molasses and 4.0 kg of water are mixed until a homogeneous mixture is obtained. The mixture is then filtered through a US Standard No. 25 sieve (0.707 mm sieve opening) and is transferred into the membrane feed tank. The mixture is run through a 15,000 molecular weight cut off (MWCO) ceramic membrane. The membrane system is operated at an outlet pressure of 40.0 psi, recirculation flow rate of 3 gallons per minute, and the temperature is varied between 60 and 77° C. (140 -170° F.). The membrane system is run until about 1050 ml of permeate is collected, then 1000 ml of the collected permeate is mixed with 5 L of ethyl acetate. The mixture is stirred for 5 minutes while maintaining the temperature between 20 and 25° C. (40 -77° F.). After the stirring is stopped, the mixture is allowed to settle for 15 minutes. After settling, the top clear layer (extract) is separated from the remainder of the permeate by decanting and is collected in a separate container. The collected extract is concentrated by evaporation and is then analyzed for isoflavones composition. The results of the analysis are shown in TABLE 1. All results are on moisture-free basis, unless otherwise stated.

TABLE 1
Composition of product derived from the method of EXAMPLE 1

| | |
|---|---|
| Daidzin (wt %) | 20.1 |
| Glycitin (wt %) | 4.9 |
| Genistin (wt %) | 30.9 |
| 6″-O-Malonyl Daidzin (wt %) | 0.0 |
| 6″-O-Acetyl Genistin (wt %) | 1.9 |
| 6″-O-Malonyl Genistin (wt %) | 1.7 |
| Daidzein (wt %) | 0.3 |
| Genistein (wt %) | 0.1 |
| Total Isoflavones (wt. %) | 59.9 |

### EXAMPLE 2

2.0 kg of soy molasses and 4.0 kg of water are mixed until a homogeneous mixture is obtained. The mixture is then filtered through a US Standard No. 25 sieve (0.707 mm sieve opening) and is transferred into the membrane feed tank. The mixture is run through a 15,000 molecular weight cut off (MWCO) ceramic membrane. The membrane system is operated at an outlet pressure of 60.0 psi, recirculation flow rate of 3 gallons per minute, and the temperature is varied between 60 and 77° C. (140 -170° F.). The membrane system is run until about 1050 ml of permeate is collected, then 1000 ml of the collected permeate is mixed with 5 L of ethyl acetate. The mixture is stirred for 5 minutes while maintaining the temperature between 20 and 25° C. (40 -77° F.). After the stirring is stopped, the mixture is allowed to settle for 15 minutes. After settling, the top clear layer (extract) is separated from the remainder of the permeate by decanting and is collected in a separate container. The collected extract is concentrated by evaporation and is then analyzed for isoflavones composition. The results of the analysis are shown in TABLE 2. All results are on moisture-free basis, unless otherwise stated.

TABLE 2
Composition of product derived from the method of EXAMPLE 2

| | |
|---|---|
| Daidzin (wt %) | 18.7 |
| Glycitin (wt %) | 5.2 |
| Genistin (wt %) | 23.5 |
| 6″-O-Malonyl Daidzin (wt %) | 0.3 |
| 6″-O-Acetyl Genistin (wt %) | 2.0 |
| 6″-O-Malonyl Genistin (wt %) | 1.8 |
| Daidzein (wt %) | 0.4 |
| Genistein (wt %) | 0.3 |
| Total Isoflavones (wt. %) | 52.2 |

### EXAMPLE 3

2.0 kg of soy molasses and 4.0 kg of water are mixed until a homogeneous mixture is obtained. The mixture is then filtered through a US Standard No. 25 sieve (0.707 mm sieve opening) and is transferred into the membrane feed tank. The mixture is run through a 15,000 molecular weight cut off (MWCO) ceramic membrane. The membrane system is operated at an outlet pressure of 40.0 psi, recirculation flow rate of 3 gallons per minute, and the temperature is maintained between 47.8 and 48.9° C. (118 -120° F.). The membrane system is run until about 1050 ml of permeate is collected, then 1000 ml of the collected permeate is mixed with 5 L of ethyl acetate. The mixture is stirred for 5 minutes while maintaining the temperature between 20 and 25° C. (40 -77° F.). After the stirring is stopped, the mixture is allowed to settle for 15 minutes. After settling, the top clear layer (extract) is separated from the remainder of the permeate by decanting and is collected in a separate container. The collected extract is concentrated by evaporation and is then analyzed for isoflavones composition. The results of the analysis are shown in TABLE 3. All results are on moisture-free basis, unless otherwise stated.

TABLE 3
Composition of product derived from the method of EXAMPLE 3

| | |
|---|---|
| Daidzin (wt %) | 20.8 |
| Glycitin (wt %) | 5.7 |
| Genistin (wt %) | 27.3 |
| 6″-O-Malonyl Daidzin (wt %) | 0.0 |
| 6″-O-Acetyl Genistin (wt %) | 1.3 |
| 6″-O-Malonyl Genistin (wt %) | 1.9 |
| Daidzein (wt %) | 0.2 |
| Genistein (wt %) | 0.1 |
| Total Isoflavones (wt. %) | 57.3 |

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for producing a soy isoflavone concentrate, comprising the steps of:
(a) providing soy molasses;
(b) diluting the soy molasses with water to obtain water-diluted soy molasses;
(c) subjecting the water-diluted soy molasses to ultrafiltration to obtain a permeate;
(d) extracting the permeate with ethyl acetate to obtain an extract; and
(e) removing ethyl acetate from the extract to obtain a soy isoflavone concentrate.

2. The process of claim 1, wherein said diluting step (b) comprises diluting the soy molasses with water at a ratio of at least 1:1 (water:soy molasses).

3. The process of claim 1, wherein said diluting step (b) comprises diluting soy molasses with water at a ratio of at least 2:1 (water:soy molasses).

4. The process of claim 1, wherein said subjecting step (c) comprises subjecting the water-diluted soy molasses to ultrafiltration using a membrane having a molecular weight cut-off (“MWCO”) of between 1,000 and 300,000.

5. The process of claim 1, wherein said subjecting step (c) comprises subjecting the water-diluted soy molasses to ultrafiltration using a membrane having a molecular weight cut-off (“MWCO”) of between 5,000 and 100,000.

6. The process of claim 1, wherein said subjecting step (c) comprises subjecting the water-diluted soy molasses to ultrafiltration at a temperature of between 50° C. and 90° C.

7. The process of claim 1, wherein said subjecting step (c) comprises subjecting the water-diluted soy molasses to ultrafiltration using one of a ceramic membrane and a spiral wound membrane.

8. The process of claim 1, further comprising the additional step of pre-filtering the water-diluted soy molasses, between said dilution step (b) and said subjecting step to ultrafiltration step (c).

9. The process of claim 1, further comprising the additional step, after said extracting step (d), of again extracting the permeate with ethyl acetate to obtain an extract.

10. The process of claim 1, wherein in said extracting step (d), the ratio of ethyl acetate to permeate is between 1:1 and 20:1 (ethyl acetate:permeate).

11. A soy isoflavone concentrate, comprising:
a) at least 50 wt. % isoflavones on a moisture-free basis, inclusive of:
b) at least 15 wt. % daidzin;
c) at least 20 wt. % genistin; and
d) at least 4 wt. % glycitin.

12. The soy isoflavone concentrate of claim 11, further comprising a genistin:glycitin ratio of at least 3.0.

13. The soy isoflavone concentrate of claim 11, further comprising a genistin:daidzin ratio of at least 1.0.

14. The soy isoflavone concentrate of claim 13, wherein said genistin:daidzin ratio is at least 1.2.
